(19) United States
(12) Patent Application Publication
(10) Pub. No.: US 2019/0390509 A1
(43) Pub. Date: Dec. 26, 2019

(54) VISUAL BIOMETRIC CONTROLLED SMART PET DOOR

(71) Applicant: Brendan Scott Chatterton, Boca Raton, FL (US)

(72) Inventor: Brendan Scott Chatterton, Boca Raton, FL (US)

(21) Appl. No.: 16/448,698

(22) Filed: Jun. 21, 2019

Related U.S. Application Data
(60) Provisional application No. 62/688,038, filed on Jun. 21, 2018.

(51) Int. Cl. E06B 7/32; A01K 29/00; E05B 47/00; G07C 9/00

(52) U.S. Cl. CPC E06B 7/32; A01K 29/00; E05Y 2900/132; G07C 9/00563; E05B 47/0001

(57) ABSTRACT

A smart pet door system embodying a biometrically-controlled pet door is provided. The pet door provides sensors and data capture devices such as image capture devices and microphones along an external door frame for capturing biometric data for authentication of predetermined pet(s) prior to electrically moving the pet door from a locked condition to an unlocked condition by way of a biometric modality. The biometric modality may be coupled to a remote computing device. The biometric modality is adapted to analyze and identify peripheral data beyond that of the predetermined pet(s), thereby maintaining a locked condition upon identifying threats conveyed by the peripheral data.

### CROSS-REFERENCE TO RELATED APPLICATION

This application claims the benefit of priority of U.S. provisional application No. 62/688,038, filed 21 Jun. 2018, the contents of which are herein incorporated by reference.

### BACKGROUND OF THE INVENTION

The present invention relates to pet doors and, more particularly, a biometrically-controlled smart pet door.

Current pet doors cannot provide access based on biometrics; rather, existing products provide access by fobs, which can fail. For example, when the fob gets wet, it can malfunction, leaving the pet stuck outside. Additionally, an untoward individual can steal the fob in order to trespass through the pet door.

As can be seen, there is a need for a biometrically-controlled smart pet door adapted to biometrically authenticate preselected pets. Moreover, such a system must be adapted to adjust to minor alterations in appearance resulting from sloppy play or grooming. Furthermore, the biometric authentication embodied by a pet door system should be adapted to recognize everything in view, such as an untoward individual attempting to gain unlawful entry via the pet door by, for instance, forcing the pet into view to obtain false authentication. The biometrically-controlled smart pet door system embodied by the present invention enables a plurality of modes of authentication for addressing the above-mentioned identification issues. Additionally, the present invention affords no separate fob which can be damaged, lost or stolen.

### SUMMARY OF THE INVENTION

In one aspect of the present invention, a smart pet door system, including the following: an exterior door frame defining an opening; a pet door operatively associated with the opening so as to move between an accessible condition and a closed condition making the opening inaccessible; an electrically controlled locking mechanism for moving the pet door between an unlocked condition and a locked condition preventing the pet door from pivoting; a biometric modality electrically coupled to said locking mechanism; and a plurality of biometric data capture devices disposed along the exterior door frame, wherein the plurality of biometric data capture devices are coupled to the biometric modality, and wherein the biometric modality is configured to identify at least one predetermined pet based in part on data captured by the plurality of biometric data capture devices.

In another aspect of the present invention, the smart pet door system further includes the biometric modality configured to identify threats conveyed by said data captured that is peripheral to the at least one predetermined pet.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention;

FIG. 3 is an exploded view of an exemplary embodiment of the present invention;

FIG. 4 is a rear view of an exemplary embodiment of the present invention;

FIG. 5 is a front view of an exemplary embodiment of the present invention;

FIG. 6 is a front view of an exemplary embodiment of the present invention, with an interior frame 18 and the power source 32 removed for clarity; and

FIG. 7 is a perspective view of an exemplary embodiment of the present invention, illustrating swinging of door 22 with a lock 16 disengaged.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a smart pet door system embodying a biometrically-controlled pet door. The pet door provides sensors and data capture devices such as image capture devices and microphones along an external door frame for capturing biometric data for authentication of predetermined pet(s) prior to electrically moving the pet door from a locked condition to an unlocked condition by way of a biometric modality. The biometric modality may be coupled to a remote computing device. The biometric modality is adapted to analyze and identify peripheral data beyond that of the predetermined pet(s), thereby maintaining a locked condition upon identifying threats conveyed by the peripheral data.

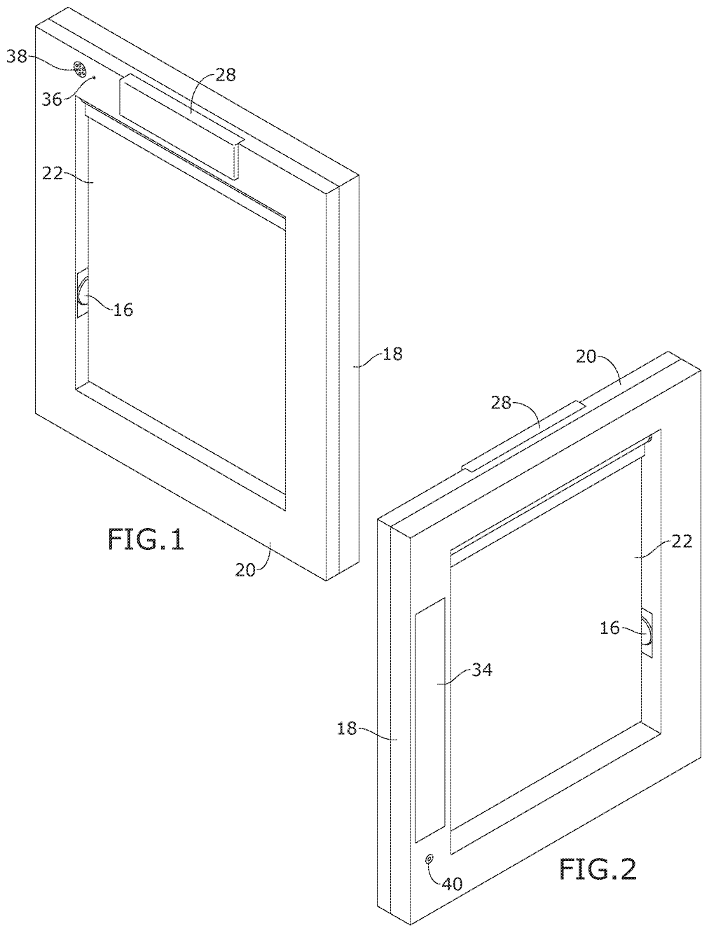

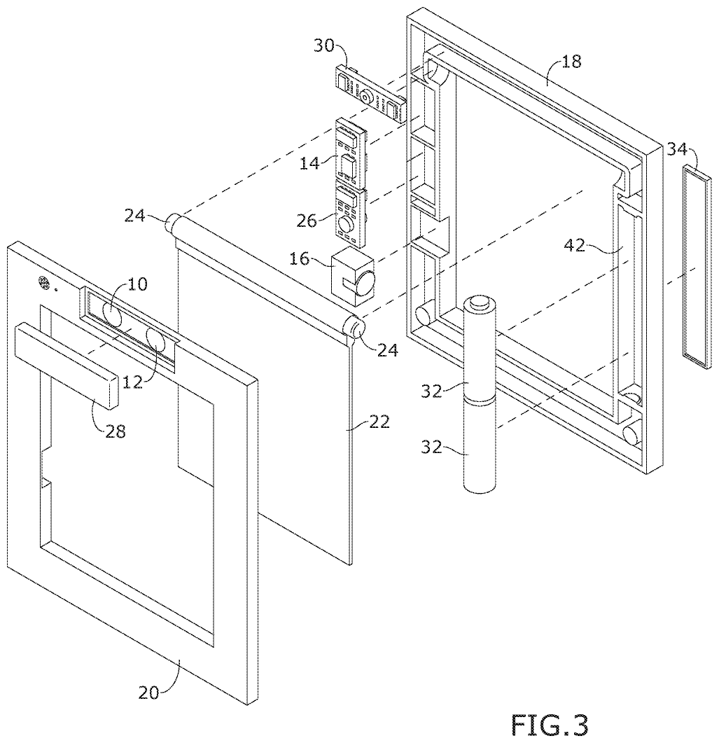

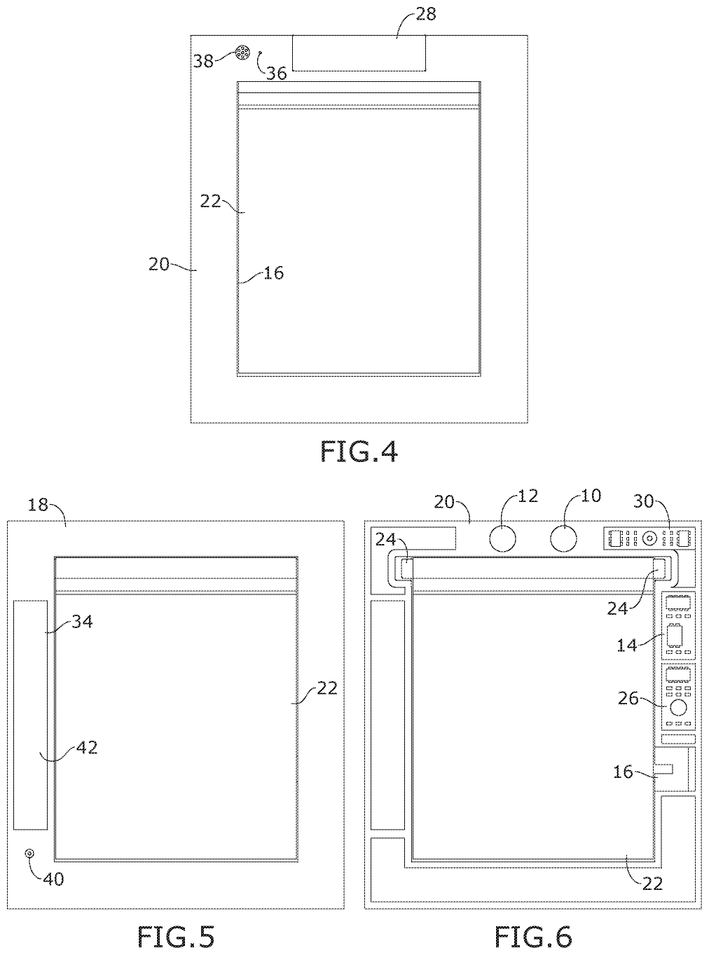

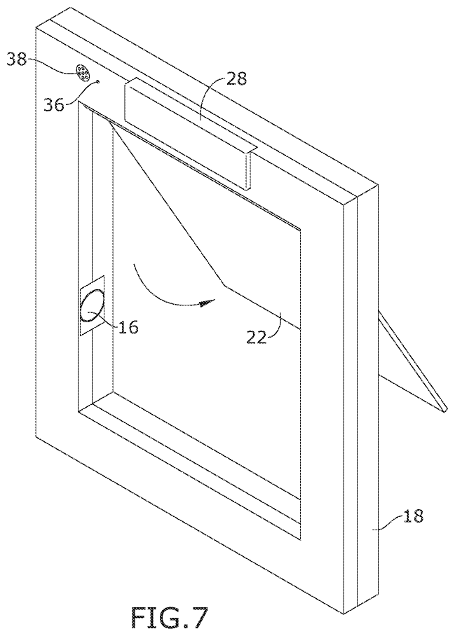

Referring now to FIGS. 1 through 7, the present invention may include a smart pet door system 100 embodying a biometrically controlled pet door 22 pivotally connected within an opening defined by an interior door frame 18 and/or exterior door frame 20. The pivotal connection may be by way of a pivot point 24, such as a hinge. The smart pet door system 100 provides a locking mechanism 16 electrically movable, by way of a lock circuitry 26, between a locked condition and an unlocked condition based on proper biometric authentication by way of a biometric modality, wherein the locked condition prevents the pivoting of the pet door 22. A plurality of sensors 12 and data capture devices such as a microphone 36 and a visual image capturing input device 10 may be housed in and/or mounted along the exterior door frame 20 for capturing biometric data from outside the external door frame 20. The data capture sensors 12 and data capture devices 10 and 36 are coupled with a data transmitter 14 for communicating with the biometric modality. The data capture devices may be housed in a sensor panel 28 in certain embodiments. The exterior door frame 20 may provide a speaker 38 for a user to communicate commands to a pet outside of the exterior door frame 20.

The interior door frame 18 may provide audio components 30, as well as a power supply 32, such as a battery, in a power supply compartment 42 coupled to a power control panel 34 and a charging port 40.

The biometric modality may be a software application of a remote computing device. The biometric modality may be computer recognition software. The computing device may include at least one processing unit coupled to a form of memory including, but not limited to, a server, a desktop, laptop, and smart device, such as, a tablet and smart phone. The computing device includes a program product including a machine-readable program code for causing, when executed, the computing device to perform steps. The program product may include software which may either be loaded onto the computing device or accessed by the computing device. The loaded software may include an application on a smart device. The software may be accessed by the computing device using a web browser. The computing device may access the software via the web browser using the internet, extranet, intranet, host server, internet cloud and the like.

The visual image capturing input device 10 and plurality of sensors 12 may be adapted to obtain biometric data from the subject. The data transmitter 14 will send the biometric data (captured visual imagery/data) to the remote computing device to undergo authentication through the biometric modality. Thus, authentication/admission is obtained remotely based on the biometric data at near the door frame and applied against known biometrics of a preselected pet or pets. While facial recognition, a method used in other industries, limits authentication to part the entity undergoing verification, the biometric data used for this embodiment may include the entire body of a pet, matching it, as well as facial features, to visual biometric data in memory. Likewise, the system may be adapted to recognize non-preselected pet entities and thus not grant admission when unrecognized entities are present under the premise that the unrecognized entity may be an individual using the pet as a trojan horse. The data transmitter 14 will receive authentication or denial and so communicate to the locking mechanism 16. The locking mechanism 16 is operatively associated with the system 100 so that an authentication/admission would temporarily move the locking mechanism 16 to an unlocked condition for a predetermined amount of time.

A method of making the present invention would include an individual assembling the aforementioned components in such a way that they could perform their purpose in accordance with the disclosure herein. For examples, the camera/input device 10 and the plurality of sensors 12 need to be positioned to obtain external data, and the locking mechanism 16 needs to be connected to the door 22.

To improve the invention, there can be remote user control from a home or pet owner or keeper via an internet connected computing device. Additionally, audio input and output may be incorporated to allow a user to summon the pet, and also hear the pet, e.g., for the purposes of being notified of barking or whimpering. Notifications for all uses of the door may be implemented for the user, whether that be access granted, denied, or whatever else. Also, for well-trained pets, door access may be scheduled via system (i.e., the locking mechanism being moved to an unlocked condition for a temporary amount of time). The end user software can be implemented in a way that allows the user to control access with various, specific settings. For examples, the software can allow the user to keep the door locked, so that a pet may not exit. For such times, a setting may be implemented whereby the user is notified if any entity at all is detected because it is known that the pet will be inside. This additional feature would help with general security of the premise, as well as against nuisance wildlife. Furthermore, the software being capable of identifying animals and humans, the user may enable a setting whereby they are notified only of entities identified as animals or humans for the sake of convenience.

In certain embodiments, the computation of authenticating the pet may reside on the device, avoiding the need for remote computing.

A method of using the present invention may include the following. The smart pet door system 100 disclosed above may be provided. A user would install the pet door, download the related biometric authorization software application, and follow simple steps to connect the device to the internet and acquire initial biometric data of a pet. Additionally, a user can configure notifications to their preferences.

Additionally, the method of authentication, including denial due to peripheral data may be useful for general security purposes, e.g., a hostage/robbery situation, and other biometric recognition products and software. An example of a threat that can be ascertained through peripheral data is recognition of a human form.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have applications in a wide range of industries. To the extent the present application discloses a system, the method implemented by that system, as well as software stored on a computer-readable medium and executed as a computer program to perform the method on a general purpose or special purpose computer, are within the scope of the present invention. Additionally, it should be understood that if one sensor can perform the function of a plurality of sensors, a singular sensor may be used, the number of sensors not limiting the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A smart pet door system, comprising:
a frame defining an opening;
a pet door operatively associated with the opening so as to be movable between an open position and a closed position closing off the opening;
an electrically controlled locking mechanism for enabling a locked engagement with the pet door preventing the pet door from moving from the closed position;
a biometric modality electrically coupled to said locking mechanism; and
a plurality of biometric data capture devices disposed along the door frame, wherein the plurality of biometric data capture devices is coupled to the biometric modality, and wherein the biometric modality is configured to identify at least one predetermined pet based in part on data captured by the plurality of biometric data capture devices.

2. The smart pet door system of claim 1, further comprising wherein the biometric modality is configured to identify one or more threats conveyed by said data captured that is peripheral to the at least one predetermined pet, and wherein the biometric modality is configured to enable the locked engagement.

3. The smart pet door system of claim 2, wherein the one or more threats may be through recognition of a human form conveyed by the peripheral data captured.
